(19) United States
(12) Patent Application Publication
(10) Pub. No.: US 2026/0178569 A1
(43) Pub. Date: Jun. 25, 2026

(54) USING USER SIGNATURES TO RESOLVE AMBIGUITIES IN TEXT-TO-STRUCTURED QUERY LANGUAGE CONVERSIONS

(71) Applicant: AT&T Intellectual Property I, L.P., Atlanta, GA (US)

(72) Inventors: Cuong Vo, Sachse, TX (US); Theodore Johnson, New York, NY (US); Divesh Srivastava, Summit, NJ (US); Vladislav Shkapenyuk, New York, NY (US); Abhay Dabholkar, Allen, TX (US); Mark Austin, Allen, TX (US); Pavan Tagirisa, Farmers Branch, TX (US)

(21) Appl. No.: 18/991,675

(22) Filed: Dec. 22, 2024

(51) Int. Cl. G06F 16/242

(52) U.S. Cl. CPC G06F 16/243

(57) ABSTRACT

A method includes identifying a user of a text-to-SQL query system, identifying a machine learning model that has been trained based on a preference of the user to predict a presence of a target feature in an input SQL query based on a presence of a query feature in the input SQL query, receiving a question phrased in natural language, generating, using a language model, an SQL query designed to retrieve an answer to the question, extracting a set of query features and a set of target features from the SQL query, generating, using the machine learning model and based on the query features and target features, a prompt that makes a recommendation with respect to the presence of the target feature, providing the prompt to the language model to cause the language model to refine the SQL query, and querying a database using the SQL query that is refined.

The present disclosure relates generally to data management, and relates more particularly to devices, non-transitory computer-readable media, and methods for using user signatures to resolve ambiguities in text-to-structured query language conversions.

### BACKGROUND

A relational database is a type of database that stores data in tabular form, where the rows and columns represent different data attributes and the relationships between the different data attributes. Data stored in these relational databases may be managed using structured query language (SQL), which is a programming language that is used in many applications. SQL statements may be used to store, update, remove, search, and retrieve data from a relational database.

### SUMMARY

In one example, the present disclosure describes a device, computer-readable medium, and method for generating text-to-structured query language queries using query logs and data profiling. For instance, in one example, a method performed by a processing system including at least one processor includes identifying a user of a text-to-structured query language query system, identifying a machine learning model that has been trained based on at least one preference of the user to predict a presence of a target feature in an input structured query language query based on a presence of a query feature in the input structured query language query, receiving a question phrased in natural language, generating, using a language model, a structured query language query designed to retrieve an answer to the question, extracting a set of query features and a set of target features from the structured query language query, generating, using the machine learning model and based on the set of query features and the set of target features, a prompt that makes a recommendation with respect to the presence of the target feature in the structured query language query, providing the prompt to the language model to cause the language model to refine the structured query language query in response to the recommendation, and querying a database using the structured query language query that has been refined.

In another example, a non-transitory computer readable medium stores instructions which, when executed by a processing system including at least one processor, cause the processing system to perform operations. The operations include identifying a user of a text-to-structured query language query system, identifying a machine learning model that has been trained based on at least one preference of the user to predict a presence of a target feature in an input structured query language query based on a presence of a query feature in the input structured query language query, receiving a question phrased in natural language, generating, using a language model, a structured query language query designed to retrieve an answer to the question, extracting a set of query features and a set of target features from the structured query language query, generating, using the machine learning model and based on the set of query features and the set of target features, a prompt that makes a recommendation with respect to the presence of the target feature in the structured query language query, providing the prompt to the language model to cause the language model to refine the structured query language query in response to the recommendation, and querying a database using the structured query language query that has been refined.

In another example, a method performed by a processing system including at least one processor includes identifying a user of a text-to-structured query language system, presenting, to the user a plurality of text pairs, wherein each test pair of the plurality of test pairs comprises: a question phrased in natural language and a machine learning model-generated structured query language query corresponding to the question, recording, for each test pair of the plurality of test pairs in a signature table for the user, whether the user accepted or rejected the each test pair, and training a machine learning model, using the signature table as training data, to predict a presence of target features in a new structured query language query based on a set of query features present in the new structured query language query.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for using user signatures to resolve ambiguities in text-to-structure query language conversions may operate;

FIG. 2 illustrates a flowchart of an example method for using user signatures to resolve ambiguities in text-to-structure query language conversions, according to the present disclosure;

FIG. 3 illustrates an example signature table that may be constructed in accordance with the method of FIG. 2;

FIG. 4 illustrates a flowchart of an example method for using user signatures to resolve ambiguities in text-to-structure query language conversions, according to the present disclosure; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for using user signatures to resolve ambiguities in text-to-structure query language conversions. As discussed above, data stored in relational databases may be managed using SQL, which is a programming language that is used in many applications. SQL statements may be used to store, update, remove, search, and retrieve data from a relational database.

Recently, language models including large language models (LLMs) and small language models (SLMs) have been shown to be effective at generating SQL queries when trained on large textual data sets that include SQL queries and public documents describing terms and concepts commonly used in specialized domains. For instance, LLMs have been developed that are capable of writing sophisticated SQL queries with little to no description of the tables to be queried. In addition to understanding SQL, LLMs have the ability to make “common sense” associations between words and phrases and their abbreviations in field names.

To be practically useful, however, the table(s) to be queried should be described to the LLM using prompt engineering, i.e., the addition of helpful context to a user's question. For instance, providing even just the schema of a table to the LLM can be surprisingly effective. However, while existing benchmarks for prompt engineering have proven to be valuable in terms of evaluating text-to-SQL prototypes, they do not tend to reflect the real-world difficulties in text-to-SQL query generation. For instance, some benchmarks may have complex schema and collections of question/SQL pairs, where the goal is to develop a text-to-SQL strategy on a set of training data and then use the strategy on a set of unknown test data. Many of the questions, however, are ambiguous in the sense that the questions could be translated into multiple technically correct SQL queries that produce different results. This ambiguity is not an artifact of the benchmarks themselves, but rather a fundamental problem in text-to-SQL conversion.

SQL is a highly technical and precise language in which all of the substructures have precise meanings that can affect the returned result. SQL has many complexities that a casual user might not fully understand, such as NULL handling and inner versus outer joins. By contrast, a natural language such as English is unlikely to address these complexities, especially if the question is asked by a user who is not an expert in SQL. As is common to natural language, there are often many unstated assumptions about the desired answer, and these assumptions are not always communicated to the text-to-SQL LLM application in a given question.

Within the context of the present disclosure, a user question that is considered to be ambiguous or vague may be a question that can be interpreted in multiple different ways that have different meanings (and can, thus, lead to a different result or answer). As an example, the question “What time did the 2010 Formula 1 race take place on the Abu Dhabi circuit?” can be converted into the SQL query “SELECT T2.date, T2.time FROM circuits AS T1 INNER JOIN races AS T2 ON T2.circuitID=T1.circuitID WHERE T2.year=2010 AND T2.name= ‘Abu Dhabi Grand Prix.” Although the question asks for the “time” of the race, the preferred answer specified both the date and the time fields from circuits. The word “time” in this case is ambiguous, because “time” could reasonably be interpreted as referring to the time of day shown on a clock (e.g., 12:00 PM Eastern Standard Time), or the date and time (e.g., Dec. 1, 2024 at 12:00 PM Eastern Standard Time) of an event. In the case of the example, the word “time” in the question is interpreted to mean both date and time.

As another example, the question “Which football player has the shortest height?” can be converted into the SQL query “SELECT player_name FROM player ORDER BY height ASC LIMIT 1.” This example contains two ambiguities. First, records with a NULL value of height are not eliminated; as such, a record with a NULL value of height may be ordered first (depending on the database management system), and the corresponding player's name may be returned as an answer even if that player is not in fact the shortest. Though it is more likely that a non-NULL height is desired as an answer, it could also be possible that a NULL height is preferred. Alternatively, the user who posed the question may know that the height field is always non-NULL, or that the database management system orders NULL values last.

The second ambiguity in this example is that the actual height of the player is not requested in the question. A reasonable interpretation of the question could be that the user only wants to know the player's name, or that the user wants to know both the player's name and the player's height.

As another example, the question “Please specify all of the schools and their related mailing zip codes that are under John Doe's administration” can be converted into the SQL query “SELECT school, MailZip FROM schools WHERE AdmFName1= ‘John’ AND AdmLName1= ‘Doe.” In this example, there may be three administrators, namely, AdmXname1, AdmXname2, and AdmXname3. Thus, when asking for “under John Doe's administration,” one reasonable interpretation of the question is that John Doe is the chief administrator (e.g., admXname1), but another reasonable interpretation is that John Doe is any one of the three administrators.

Examples of the present disclosure improve text-to-SQL conversion by observing one or more user preferences. In one example, a user may be identified (e.g., through authentication) during a series of interactions with a text-to-SQL application, and the interactions may be logged. The interactions allow the user to accept or reject SQL queries, and the user's responses allows the application to build a profile for the user, where the profile includes “fingerprints” of the user's accepted and rejected queries. By matching the fingerprint of a newly generated query to a fingerprint of the profile, the application can determine which features, if any, should be added to or deleted from the newly generated query. This process may repeat until the newly generated query matches the fingerprints of the accepted queries but does not match the fingerprints of the rejected queries. The newly generated (and now refined) query may then be presented to the user, and the user's response (e.g., accept or reject) to the newly generated query may be added along with the newly generated query as a new fingerprint to the profile. In this manner, the text-to-SQL application may learn one or more user preferences and may generate queries that are more likely to be accepted by the user.

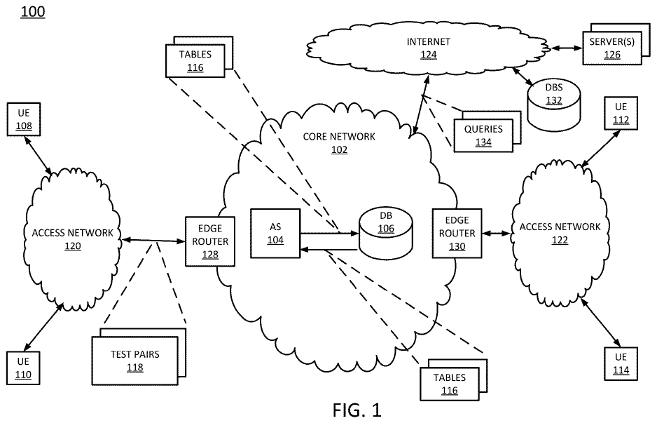

Although examples of the present disclosure are discussed below within the context of LLMs, it will be appreciated that the same techniques could be used to generate prompts for query generation by other types of language models, including SLMs. These and other aspects of the present disclosure are discussed in further detail with reference to FIGS. 1-5, below.

To further aid in understanding the present disclosure, FIG. 1 illustrates an example system 100 in which examples of the present disclosure for using user signatures to resolve ambiguities in text-to-structure query language conversions may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

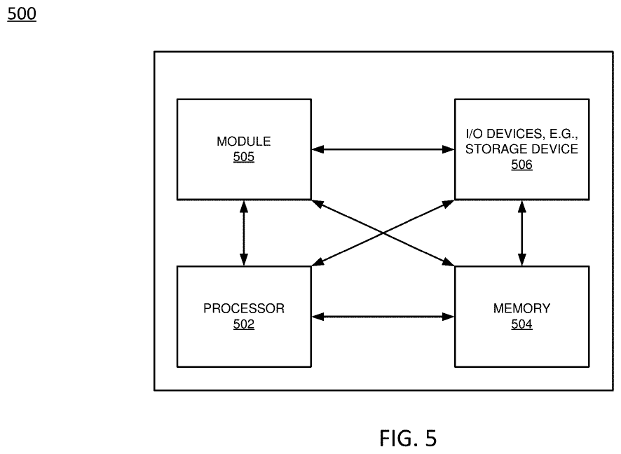

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 500 depicted in FIG. 5, and may be configured as described below. For example, the user endpoint devices 108, 110, 112, and 114 may each comprise a smart phone, a tablet computer, a laptop computer, a gaming device, a wearable smart device (e.g., a smart watch, a head mounted display, or the like), an IoT device, a bank or cluster of such devices, and the like.

In one example, one or more servers 126 and one or more databases 132 may be accessible to user endpoint devices 108, 110, 112, and 114 via Internet 124 in general. The server(s) 126 and DBs 132 may be associated with Internet software applications that may exchange data with the user endpoint devices 108, 110, 112, and 114 over the Internet 124. In one example, at least some of the servers 126 and DBs 132 host applications that perform text-to-SQL conversions to convert natural language questions submitted by users of the user endpoint devices 108, 110, 112, and 114 into SQL queries designed to retrieve desired information from DBs 132.

In accordance with the present disclosure, the AS 104 may be configured to provide one or more operations or functions in connection with examples of the present disclosure for using user signatures to resolve ambiguities in text-to-structure query language conversions, as described herein. For instance, in one example, the AS 104 may be part of a database management system. In a further example, the AS 104 may include a large language model that is trained to automatically convert questions phrased in natural language into SQL queries, such as SQL query 134, for execution against a database, such as the DB 106 or the DB 132.

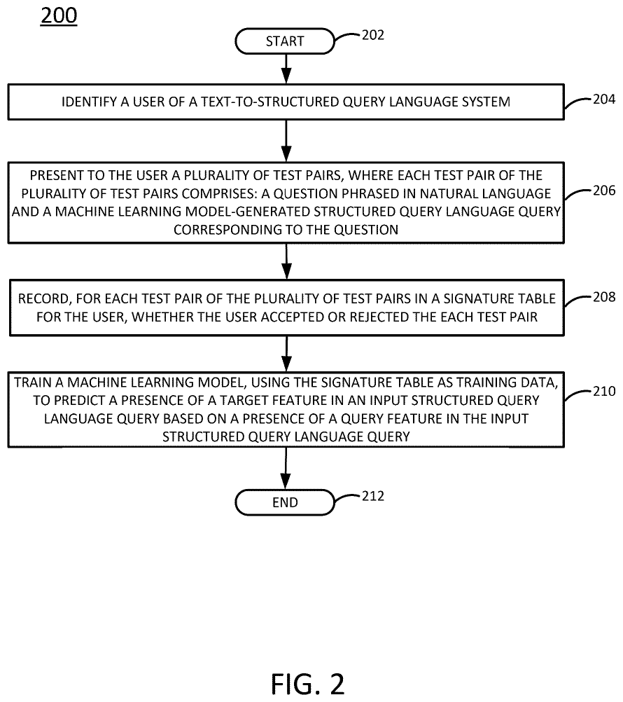

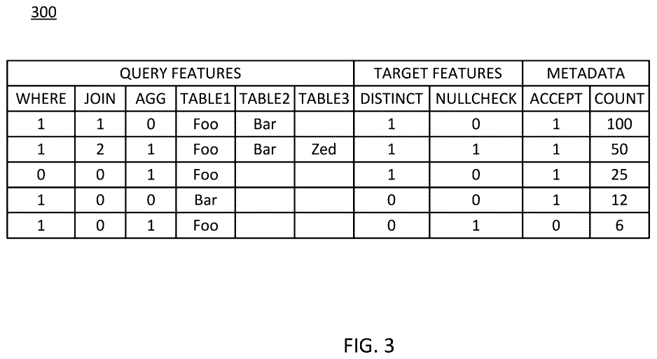

In one example, the AS 104 may present test pairs 118 to users via UEs 108 and 110, where each test pair 118 includes: (1) a question phrased in natural language; and (2) a machine learning model-generated structured query language query corresponding to the question. The AS 104 may collect feedback from the users regarding the test pairs 118 (e.g., whether the users accept or reject each SQL query as being representative of the corresponding question). Based on the feedback, the AS 104 may construct a signature table 116 for each user (or group of users sharing a common role), and may store the signature tables 116 in the DB 106. One example of a method for constructing a signature table for a user is discussed in greater detail below with respect to FIG. 2. An example signature table is illustrated in FIG. 3.

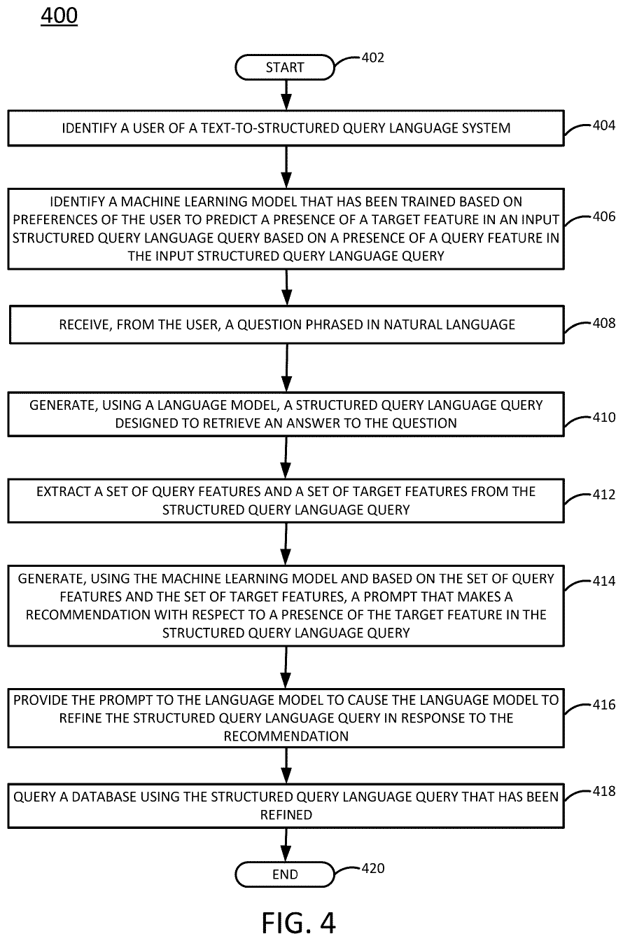

In a further example, the AS 104 may support a text-to-SQL system that receives questions from the users (via UEs 108 and 110) that are phrased in natural language. The AS 104 may convert the questions phrased in natural language to SQL queries 134 that may be executed against the DBs 132. In one example, when converting a question to an SQL query 134, the AS 104 may identify the user from whom the questions were received and may retrieve a signature table 116 for the user from the DB 106. The signature table may be used to help refine the SQL query 134, and in particular to help resolve ambiguities in the question that may lead to an imprecise conversion to the SQL query 134. One example of a method for using a signature table to help perform text-to-SQL conversion is discussed in greater detail below with respect to FIG. 4.

The AS 104 may comprise one or more physical devices, e.g., one or more computing systems or servers, such as computing system 500 depicted in FIG. 5, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure. In one example, the DB 106 may comprise a physical storage device integrated with the AS 104 (e.g., a database server or a file server), or attached or coupled to the AS 104, in accordance with the present disclosure.

In one example, the AS 104 may load instructions into a memory, or one or more distributed memory units, and execute the instructions for using user signatures to resolve ambiguities in text-to-structured query language conversions, as described herein.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for using user signatures to resolve ambiguities in text-to-structure query language conversions, according to the present disclosure. In particular, FIG. 2 illustrates a method for building a model that can be used to perform text-to-SQL conversions by learning user signatures. In one example, the method 200 may be performed by the AS 104 or by another element of the core network 102 illustrated in FIG. 1. However, in other examples, the method 200 may be performed by another device, such as the computing system 500 of FIG. 5, discussed in further detail below. For the sake of discussion, the method 200 is described below as being performed by a processing system (where the processing system may comprise a component of the AS 104 or by another element of the core network 102, the computing system 500, or another device).

The method 200 begins in step 202. In step 204, the processing system may identify a user of a text-to-structured query language system.

In one example, the user is an entity whose preferences are being collected by the method 200. Within this context, a “user” may refer to a user identifier (ID), which may be determined by an authentication process by which access to the text-to-SQL system is granted or may be provided by the user. However, the entity that the user represents may be any one of a plurality of different ways to select text-to-SQL interactions for learning user preferences. For instance, a user may also be a user ID when working on a specific database or schema, a collection of user IDs under a role (e.g., a project), or another type of grouping.

In step 206, the processing system may present to the user a plurality of text pairs, wherein each test pair of the plurality of test pairs comprises: a question phrased in natural language and a machine learning model-generated structured query language query corresponding to the question. In one example, a retrieval-augmented generation (RAG) pipeline may be used to generate and/or retrieve test pairs to present to the user. The test pairs may be generated using knowledge of the schema of the database to be queried, as well as metadata about the database.

In step 208, the processing system may record, for each test pair of the plurality of test pairs in a signature table for the user, whether the user accepted or rejected the each test pair. In one example, the signature table comprises a data structure that records data about the test pairs and the user's responses as the user interacts with the test pairs. This recorded data may be determined by analyzing the SQL queries, extracting features of the SQL queries and metadata about the SQL queries, and determining whether the SQL queries were accepted or rejected by the user. In one example, the signature table comprises three main sections: (1) a set of query features, which will be used to determine which target features should be applied; (2) a set of target features; and (3) metadata.

In one example, the set of query features comprise properties of an SQL query that are used to predict target features. Query features may be extracted from the machine learning model-generated SQL queries that make up one portion of the test pairs presented in step 206. In one example, query features may include at least one of: the table(s) referenced by the SQL query, the number of subqueries contained in the SQL query, the number of joins contained in the SQL query, the number of fields of the table(s) returned by the SQL query, a type of field in the query; an Order By clause in the query; Null checking (f IS NOT NULL) in the query, an aggregation in the query, or a Having clause in the query. Query features may be selected by the processing system to be representative of the SQL query's structure. In one example, the query features may be determined according to at least one of the following techniques: best practices guides, database analyst or subject matter expert recommendations, or automated means (e.g., query log analysis).

The values of the query features may take any one of a number of formats, including: a binary presence/absence indicator (e.g., P/A or 0/1), a numerical count, explicit names (e.g., table names), or the like. The query features may be extracted from an SQL query using one or more of a plurality of techniques, including text matching (e.g., does “join” appear in the query text?”) or asking the language model whether a feature is present in the query. More sophisticated approaches to extracting query features may utilize SQL parsers, which may create abstract syntax trees that represent the SQL queries and which can be analyzed to extract query features with precision.

In one example, the set of target features comprises properties that can be added to or removed from the machine learning model-generated SQL queries. As with query features, target features may be determined by any one or more of several techniques, including at least one of the following techniques: best practices guides, database analyst or subject matter expert recommendations, or automated means (e.g., query log analysis). In one example, a value for a target feature is either a 0 or a 1, where a 1 indicates that the target feature is present in the SQL query and a 0 indicates that the target feature is not present in the SQL query. The presence or absence of a target feature can be determined by any one or more of several techniques, including text matching and SQL parsing. In one example, a target feature may be one or more of: whether a SELECT is a SELECT DISTINCT; whether there is a NULL check, whether an ORDER BY involves a constraint on a subquery, whether there is a join to table T which does not contribute any fields to the output (i.e., filter only), a number of fields, or a data manipulation.

In one example, the metadata may include data about an SQL query other than features. In one example, the metadata may include one or more of the following types of data: user ID, time/date of submission, rule counts, or accept/reject indictors. If the metadata includes an accept/reject indicator, then the indicators are set accordingly (e.g., a 1 may indicate that the user accepted the SQL query, whereas a 0 may indicate that the user did not accept or rejected the SQL query). If the metadata does not include an accept/reject indicator, then the signature table may only record data (i.e., features and metadata) for SQL queries that the user accepts. If the metadata includes a count, and if an entry already exists in the table for a given signature, then the count for the given signature is incremented (e.g., by one). If the metadata includes a count, and if an entry does not already exist in the table for the given signature, then a new entry for the given signature is added to the signature table.

FIG. 3, for instance, illustrates an example signature table 300 that may be constructed in accordance with step 208 of the method 200 of FIG. 2. The example signature table 300 may be created for a user ID of “ad895d” and may include query features of: WHERE (i.e., does the SQL query include a WHERE clause), JOIN (i.e., the number of joins contained in the SQL query), AGG (i.e., does the top-level SQL query perform aggregation), and Table1, Table2, and Table3 (i.e., three distinct tables referenced by the SQL query in a deterministic order, such as an alphabetical order). The target features of the example signature table 300 may include: DISTINCT (i.e., does the top-level SQL query use Select Distinct?) and NULLCHECK (i.e., does the SQL query use the IS NOT NULL predicate?). A review of the example signature table 300 shows that whenever table Foo is referenced in an SQL query, the top-level selection of the SQL query should be a Select Distinct (i.e., no repetitions in the query output).

In step 210, the processing system may train a machine learning model, using the signature table as training data, to predict a presence of target features in a new structured query language query based on a set of query features present in the new structured query language query. In one example, predicting the presence of the target features also necessarily predicts the absence of the target features. For instance, if the machine learning model predicts that a given target feature is not present, then the machine learning model has necessarily predicted that the given target feature is absent.

In one example, the records stored in the signature table may be pre-processed prior to training the machine learning model, to fit the type of the machine learning model. For instance, pre-processing may include discarding signatures that were not accepted by the user, duplicating records with counts by a number of times equal to the value in the count field (and deleting the count field), and the like.

The machine learning model may comprise any one of a number of machine learning models, including deep learning models and boosted trees. In one particular example, the machine learning model may comprise a fine tuned large language model (LLM). Fine tuning of the LLM may be performed in a variety of different ways, including full parameter fine tuning, turning just some of the parameters of the LLM with Low Rank Adaptation (LORA) (which just tunes the last stage of the LLM), and other ways. In one example, the machine learning model may be a single machine learning model that operates alone to predict the respective presences of a plurality of target features, based on the query features.

In another example, the machine learning model may be one of a plurality of machine learning models that work together, where each machine learning model of the plurality of machine learning models is trained to predict the presence of a different target feature based on the query features and a subset of the other target features. For instance, in one example, the plurality of machine learning models may include one machine learning model per target feature, where the one machine learning model predicts the presence of one target feature based on the query features and the remaining target features.

In one example, the machine learning model may be trained once a predefined threshold number of test pairs has been presented to the user. In another example, the machine learning model may be repeatedly re-trained as more test pairs are presented to the user. In the latter case, an initial machine learning model may be trained for the user by using signatures from other entities, and the initial machine learning model may subsequently be refined after a plurality of test pairs has been presented to the user. The method 200 may end in step 212.

To further aid in understanding the present disclosure, FIG. 4 illustrates a flowchart of an example method 400 for using user signatures to resolve ambiguities in text-to-structure query language conversions, according to the present disclosure. In particular, FIG. 4 illustrates a method for building a model that can be used to perform text-to-SQL conversions by learning user signatures. In one example, the method 400 may be performed by the AS 104 or by another element of the core network 102 illustrated in FIG. 1. However, in other examples, the method 400 may be performed by another device, such as the computing system 500 of FIG. 5, discussed in further detail below. For the sake of discussion, the method 400 is described below as being performed by a processing system (where the processing system may comprise a component of the AS 104 or by another element of the core network 102, the computing system 500, or another device).

The method 400 begins in step 402. In step 404, the processing system may identify a user of a text-to-structured query language query system. As discussed above, the user may be identified by an authentication process by which access to the text-to-SQL system is granted or may be provided by the user. For instance, based on an authentication process, the processing system may identify the user as “user ID ad895d” or as a specific role within an enterprise.

In step 406, the processing system may identify a machine learning model that has been trained based on one or more preferences of the user to predict a presence of a target feature in an input structured query language query based on a presence of a query feature in the input structured query language query. In one example, the machine learning model may comprise a fine tuned LLM. Fine tuning of the LLM may be performed in a variety of different ways, including full parameter fine tuning, turning just some of the parameters of the LLM with LORA, and other ways.

In one example, the machine learning model may be trained according to the method 200, described above. As discussed above, a machine learning model that is trained according to the method 200 may be user-specific (e.g., different users may intend different meanings for the same words or phrases). In one example, a plurality of user-specific machine learning models may be stored in a database that is accessible to the processing system. Each machine learning model of the plurality of user-specific machine learning models may be associated with a specific user ID, user name, role within an enterprise, or the like. Thus, once the user has been identified, the identity of the user may be used as in index into the database to retrieve the correct machine learning model.

In step 408, the processing system may receive, from the user, a question phrased in natural language. In one example, the question may include one or more ambiguities (e.g., one or more terms that may be interpreted in more than one different way). For instance, the question may be phrased as “What time did the 2010 Formula 1 race take place on the Abu Dhabi circuit?” The word “time” in this case is ambiguous, because “time” could reasonably be interpreted as referring to the time of day shown on a clock (e.g., 12:00 PM Eastern Standard Time), or the date and time (e.g., Dec. 1, 2024 at 12:00 PM Eastern Standard Time) of an event.

In step 410, the processing system may generate, using a language model, a structured query language query designed to retrieve an answer to the question. In one example, the language model may be an LLM or an SLM that is designed to convert questions phrased in natural language into SQL queries.

In step 412, the processing system may extract a set of query features and a set of target features from the structured query language query. As discussed above, the set of query features may include at least one of: the table(s) referenced by the SQL query, the number of subqueries contained in the SQL query, the number of joins contained in the SQL query, the number of where clauses contained in the SQL query, the number of fields of the table(s) returned by the SQL query, whether the top-level SQL query performs aggregation, and/or other features. The target features may include at least one of: whether the top-level SQL query uses Select Distinct, whether the SQL query uses the IS NOT NULL predicate, and/or other features.

In step 414, the processing system may generate, using the machine learning model and based on the set of query features and the set of target features, a prompt that makes a recommendation with respect to a presence of the target feature in the structured query language query.

For instance, in one example, the processing system may provide the set of query features and the set of target features as inputs to the machine learning model. Based on these inputs, the machine learning model may make a prediction as to whether the target feature should be added to the SQL query (if not already included in the set of target features) or removed from the SQL query (if included in the set of target features). As discussed above, this prediction is based on one or more preferences of the user, which are captured in the training data used to train the machine learning model. The prompt may thus prompt the language model to either add the target feature to the SQL query or remove the target feature from the SQL query.

It should be noted that many machine learning models return a probability of a result as opposed to a binary (e.g., yes/no, accept/reject) recommendation. For instance, the machine learning model may predict DISTINCT with a confidence of ninety-five percent and NULLCHECK with a confidence of five percent. In a case like this, a predefined threshold may be set to help determine how to configure the prompt. If the confidence of a prediction is higher than the threshold, then the prompt will recommend that the target feature be included in the SQL query; if the confidence is lower than the threshold, then the prompt will recommend that the target feature be excluded from the SQL query.

In another example, the recommendation as to whether to include or exclude the target feature may be made probabilistically. For instance, if the confidence associated with the target feature is seventy-five percent, then the target feature may be recommended for inclusion seventy-five percent of the time and recommended for exclusion twenty-five percent of the time.

In step 416, the processing system may provide the prompt to the language model to cause the language model to refine the structured query language query in response to the recommendation. For instance, if the prompt recommends that the target feature should be removed from the SQL query, the language model may refine the SQL query in a manner that omits the target feature. Alternatively, if the prompt recommends that the target feature should be added to the SQL query, the language model may refine the SQL query in a manner that adds the target feature to the SQL query.

In one example, the processing system may be configured to provide only prompts that recommend target features to be added into an SQL query, or to provide only prompts that recommend target features to be removed from an SQL query.

In step 418, the processing system may query a database using the structured query language query that has been refined. The database may be queried according to any known techniques for querying databases using SQL queries. In one example, the processing system may engage in multiple rounds of interaction and feedback with the user before the SQL query has been refined to the point that the user accepts the SQL query (or before the text-to-SQL session is terminated). During each round of interaction, a signature may be created from the SQL query, and this signature may be evaluated by the machine learning model against a list of target feature recommendations. If any target feature recommendation differs from the current signature, and the target feature recommendation is not overridden by user instructions, then the language model may be invoked again with prompts that recommend the inclusion or exclusion of a target feature. For instance, the DISTINCT feature can be recommended for use by the inclusion of the following text in a prompt:
Use Select Distinct
   or recommended for exclusion by inclusion of this alternative text in the prompt:
Use Select, not Select Distinct.
   This interaction may not be visible to the user and may continue until the SQL query matches the recommendation of the machine learning model or a retry limit is reached.

The method 400 may end in step 420.

It should be noted that a user interaction with the text-to-SQL system may involve multiple rounds of SQL generation and user feedback. If, at any point, the user feedback goes against a recommendation of the machine learning model, then the recommendation may be ignored by the processing system. For instance, if the user feedback indicates that DISTINCT should not be used in the SELECT clause of an SQL query, then any recommendation generated by the machine learning model that includes SELECT DISTINCT may be ignored by the processing system going forward.

Although not expressly specified above, one or more steps of the method 200 or method 400 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 and FIG. 4 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 200 or method 400 may be implemented as the system 500. For instance, the AS 104 of FIG. 1 (such as might be used to perform the method 200 or the method 400) could be implemented as illustrated in FIG. 5. As depicted in FIG. 5, the system 500 comprises a hardware processor element 502, a memory 504, a module 505 for using user signatures to resolve ambiguities in text-to-structured query language conversions, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for using user signatures to resolve ambiguities in text-to-structured query language conversions may include circuitry and/or logic for performing special purpose functions relating to generating prompts for SQL queries. The input/output devices 506 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for using user signatures to resolve ambiguities in text-to-structured query language conversions can be loaded into memory 504 and executed by hardware processor element 502 to implement the steps, functions or operations as discussed above in connection with the example method 200 or example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for using user signatures to resolve ambiguities in text-to-structured query language conversions (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

1. A method comprising:
identifying, by a processing system including at least one processor, a user of a text-to-structured query language query system;
identifying, by the processing system, a machine learning model that has been trained based on at least one preference of the user to predict a presence of a target feature in an input structured query language query based on a presence of a query feature in the input structured query language query;
receiving, by the processing system from the user, a question phrased in natural language;
generating, by the processing system using a language model, a structured query language query designed to retrieve an answer to the question;
extracting, by the processing system, a set of query features and a set of target features from the structured query language query;
generating, by the processing system using the machine learning model and based on the set of query features and the set of target features, a prompt that makes a recommendation with respect to the presence of the target feature in the structured query language query;
providing, by the processing system, the prompt to the language model to cause the language model to refine the structured query language query in response to the recommendation; and
querying, by the processing system, a database using the structured query language query that has been refined.

2. The method of claim 1, wherein the question includes at least one term that is capable of being interpreted in more than one different way.

3. The method of claim 1, wherein the machine learning model is one of a plurality of user-specific machine learning models stored in a second database that is accessible to the processing system.

4. The method of claim 1, wherein the set of query features includes at least one of: a table referenced by the structured query language query, a number of subqueries contained in the structured query language query, a number of joins contained in the structured query language query, a number of where clauses contained in the structured query language query, a number of fields of the table returned by the structured query language query, whether a top-level structured query language query performs aggregation, a type of field in the structured query language query, an order by clause in the structured query language query, a null check in the structured query language query, an aggregation in the structured query language query, or a having clause in the structured query language query.

5. The method of claim 1, wherein the set of target features includes at least one of: whether a top-level structured query language query uses select distinct, whether the structured query language query uses an is not null predicate, whether the structured query language query uses a null check, whether the structured query language query uses an order by that involves a constraint on a subquery, whether the structured query language query uses a join to table which does not contribute any fields to an output, a number of fields in the structured query language query, or a data manipulation in the structured query language query.

6. The method of claim 1, wherein the machine learning model takes the set of query features and the set of target features as inputs and generates as an output a prediction as to whether the target feature should be added to the structured query language query or removed from the structured query language query.

7. The method of claim 6, wherein the language model adds the target feature to the structured query language query prior to the querying, in response to the prompt.

8. The method of claim 6, wherein the language model removes the target feature from the structured query language query prior to the querying, in response to the prompt.

9. The method of claim 1, wherein the machine learning model is trained using a signature table for the user as training data.

10. The method of claim 9, wherein the signature table records responses of the user to a plurality of test pairs, and wherein each test pair of the plurality of test pairs comprises: a test question phrased in natural language and a machine learning model-generated structured query language query corresponding to the test question.

11. The method of claim 10, wherein the responses indicate, for each test pair of the plurality of test pairs, whether the user accepted or rejected the structured query language query corresponding to the test question as an accurate conversion of the test question.

12. A non-transitory computer readable medium storing instructions which, when executed by a processing system including at least one processor, cause the processing system to perform operations, the operations comprising:
identifying a user of a text-to-structured query language query system;
identifying a machine learning model that has been trained based on at least one preference of the user to predict a presence of a target feature in an input structured query language query based on a presence of a query feature in the input structured query language query;
receiving a question phrased in natural language;
generating, using a language model, a structured query language query designed to retrieve an answer to the question;
extracting a set of query features and a set of target features from the structured query language query;
generating, using the machine learning model and based on the set of query features and the set of target features, a prompt that makes a recommendation with respect to the presence of the target feature in the structured query language query;
providing the prompt to the language model to cause the language model to refine the structured query language query in response to the recommendation; and
querying a database using the structured query language query that has been refined.

13. A method comprising:
identifying, by a processing system including at least one processor, a user of a text-to-structured query language system;
presenting, by the processing system to the user a plurality of text pairs, wherein each test pair of the plurality of test pairs comprises: a question phrased in natural language and a machine learning model-generated structured query language query corresponding to the question;
recording, by the processing system for each test pair of the plurality of test pairs in a signature table for the user, whether the user accepted or rejected the each test pair; and
training, by the processing system, a machine learning model, using the signature table as training data, to predict a presence of target features in a new structured query language query based on a set of query features present in the new structured query language query.

14. The method of claim 13, wherein the plurality of test pairs is generated using a retrieval-augmented generation pipeline.

15. The method of claim 13, wherein the signature table further records, for each test pair: a set of query features, a set of target features, and metadata.

16. The method of claim 15, wherein the set of query features is used to determine which features of the set of target features should be applied to the machine learning model-generated structured query language query.

17. The method of claim 15, wherein the set of query features includes at least one of: a table referenced by the new structured query language query, a number of subqueries contained in the new structured query language query, a number of joins contained in the new structured query language query, a number of where clauses contained in the new structured query language query, a number of fields of the table returned by the new structured query language query, or whether a top-level new structured query language query performs aggregation.

18. The method of claim 15, wherein the set of target features includes at least one of: whether a top-level structured query language query uses select distinct or whether the structured query language query uses an is not null predicate.

19. The method of claim 13, wherein the machine learning model is at least one of: a deep learning model or a boosted tree.

20. The method of claim 13, wherein the machine learning model is one of a plurality of machine learning models that work together, and wherein each machine learning model of the plurality of machine learning models is trained to predict the presence of a different target feature in a given structured query language query.
